(19) United States
(12) Patent Application Publication
(10) Pub. No.: US 2005/0114838 A1
(43) Pub. Date: May 26, 2005

(54) Dynamically tunable software test verification

(76) Inventors: Keith B. Stobie, Bellevue, WA (US); Sujay Sahni, Sammamish, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(21) Appl. No.: 10/723,755

(22) Filed: Nov. 26, 2003

(51) Int. Cl. G06F 9/44

(52) U.S. Cl. 717/124

(57) ABSTRACT

Example embodiments provide methods, systems, and computer program products for controlling the amount of verification—i.e., the amount of checking or testing—done in determining the success or failure of software under test. Tunable test cases include software testing instructions organized as verification levels within a verification hierarchy. The verification levels define different amounts of checking to perform in determining if the software functions as intended. Each test case may be set to any verification level. Verification settings define the desired verification level and those software testing instructions which correspond to the desired verification levels are identified and run. The amount of testing that is external to the test case may be varied through test case groupings that are also set to desired verification levels.

### CROSS-REFERENCE TO RELATED APPLICATIONS

1. The Field of the Invention

The present invention relates to software testing technology. More specifically, the present invention relates to verifying software with tunable test cases that are capable of being set to any one of a number of verification levels.

2. Background and Related Art

Most software is developed as a number of reusable software objects, each designed to carry out one or more tasks. The utility and functionality of the software, as well as the computing system running the software, depend on the proper coding of the source code that is compiled or interpreted for execution by a processor. Coding errors usually cause a deviation from expected functionality of the software and potentially may impact other parts of the computer system (e.g., other applications, databases, the operating system, etc.) Such coding errors not only frustrate the user's computing experience with the software, but can also cause undesired effects throughout the computer system. Therefore, producers of high-quality software expend significant testing and verification efforts to eliminate errors in their software.

Market demand and the creativity of programmers and designers, however, have led to increasingly complex—yet powerful—software. As the complexity of software increases, so often does the number of lines of source code needed to implement the software. As a direct result, the potential for errors in the source code continues to increase. Accordingly, software must often be tested numerous times and in a variety of ways (before and after release) to help ensure that the software operates as intended.

In some testing environments, a tester develops automated tests that verify the operation of one or more portions of the software. For example, a test case may automate entering of input field values within a graphical user interface, calling software objects with various input parameters and under a wide range of conditions, gathering the resulting output, and determining if a test passed or failed. A tester (who may or may not be the test developer) can then execute the test case, which provides an indication of whether the object under test passed or failed (and thus whether the object is operating as intended).

Currently, test developers write separate test cases for different levels of software verification, i.e., the amount of checking that each test case performs when determining if an object passed or failed. Verification levels for testing software vary widely depending on myriad factors. For example, when determining a verification level, a test developer will often consider the time of the testing (e.g., at debug or retail build time), the desired type of testing (e.g., stress or complete testing), the object being tested, the potential parts of the system affected when running the program, etc.

In any event, there is generally a tradeoff between the amount of time consumed in running a test case and how thorough the software is tested. In particular, the more outputs that are generated and verified, the more time consuming the testing becomes. For example, a test developer may write test cases for simply testing the stress or load of the software. In such a case, the resulting outputs of the test case may be ignored and the object is considered to have passed if the software or system doesn't crash. While this form of verification allows for a quick test of the software, it does not provide a complete determination of all the effects cause by the software. Accordingly, there is usually much debate and consideration needed in determining the verification level necessary to appropriately test the software.

One problem with current test cases is that they are static in design and do not allow for ease in tuning a test case to a desired verification level, nor are they easily extensible. For example, suppose a test developer writes a test case for testing the “insert record” function of a piece of software. If the test case is written according to the above-described stress test level, then the object is considered to have passed if the system doesn't crash when the insert record object is run. Although the stress test is useful in running a number of test cases within a short time period, such a test does not provide enough information to determine if the object actually worked. For instance, there is no guarantee that a record was actually inserted or that a record wasn't inserted twice. Further, the insert record function could have written over some other record that will affect the system at a later time or might have affected the system in any number of unknown ways.

Accordingly, different verification levels to test different parts of the system are need at different stages in the software development process for determining if the software functions as intended. Currently, however, test cases must be written for each desired verification level and for each stage in the software development process. In other words, a single test case cannot be reused or dynamically tuned to test software at different levels of granularity.

Another problem with current test cases is that they do not allow for a pure stress or load testing environment. For example, as describe above, an insert record stress test case simply ignores the output produced or recorded when running the test case, i.e., the system does not analyze the output. Producing the output in the first place, however, impacts the system, so it would be better not to produce it in the first place.

Yet another problem with typical test cases is that there is no mechanism for automatically determining what part of the development stage the software is being tested in. For example, current test cases cannot determine weather they are running in a debug build, as opposed to a retail build, in order to take advantage of the additional information that may be available.

### BRIEF SUMMARY OF THE INVENTION

In accordance with exemplary embodiments of the present invention, the above-identified deficiencies and drawbacks of current software testing are overcome. For example, exemplary embodiments provide for methods, systems, and computer program products that verify software under test using tunable test cases that are capable of being set to any of a number of verification levels. In one embodiment, the tunable test cases are read in. The test cases include software testing instructions that are organized as verification levels within a verification hierarchy. At least two verification levels within the verification hierarchy define different amounts of checking to perform for determining if the software functions as intended when executed. Further, verification settings, which also are read in, define desired verification levels within the verification hierarchy. A portion of software testing instructions within the test cases that correspond to the desired verification levels are then identified, and the portion of the test cases that correspond to the desired verification levels is run.

Other example embodiments provide for loading the test cases. Verification setting instructions are received for the desired verification levels from within the verification hierarchy for use in testing the software. The software is then tested at the desired verification levels by running the test cases and their software testing instructions that correspond to the desired verification level.

Still, other example embodiments provide that the above test cases can be part of one or more groups. These test groups include software testing instructions organized as verification levels within the verification hierarchy. Further, these test groups may be organized into a grouping hierarchy and can include any combination of verification levels for the test groups and the test cases.

Additional features and advantages of the invention will be set fourth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set fourth hereinafter.

### BRIEF DESCRIPTION OF THE DRAWINGS

In order to describe the manner in which the above-recited and other advantages and features of the invention cam be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates a test case with tunable amounts of testing verification levels in accordance with example embodiments;

FIGS. 1B-1C illustrates groupings of test cases and sub test groups in accordance with example embodiments;

FIG. 2 illustrates various parts of a computer system capable of being tested using the tunable testing verification in accordance with example embodiments;

FIG. 3 illustrates example steps and acts for verifying software under test in accordance with example embodiments; and

FIG. 4 illustrates an example system that provides a suitable operating environment for the present invention.

### DETAILED DESCRIPTION OF THE PREFERRED EMBODIMENTS

The present invention extends to methods, systems, and computer program products for testing software with dynamically tunable amounts of software test verification. The embodiments of the present invention may comprise a special purpose or general-purpose computer including various computer hardware, as discussed in greater detail below. Reference will now be made to the Figures wherein like structures will be provided with like or similar reference designations. It is understood that the drawings are example schematic representation of embodiments of the invention, and are not limiting of the present invention nor are they necessarily drawn to scale.

The present invention provides methods, systems and computer program products that control the amount of verification—i.e., the amount of checking or testing—done in determining the success or failure of software under test. The test cases are created as components, allowing them to be mixed and matched for varying amounts and types of testing as desired under the circumstance. Rather than custom creating test cases for each situation, the present invention provides test cases that can be designed with varying amounts of verification which can be set or tuned dynamically. For example, verification levels may vary from none (e.g., run as a load) to a complete system check (e.g., the state of an entire computer or network).

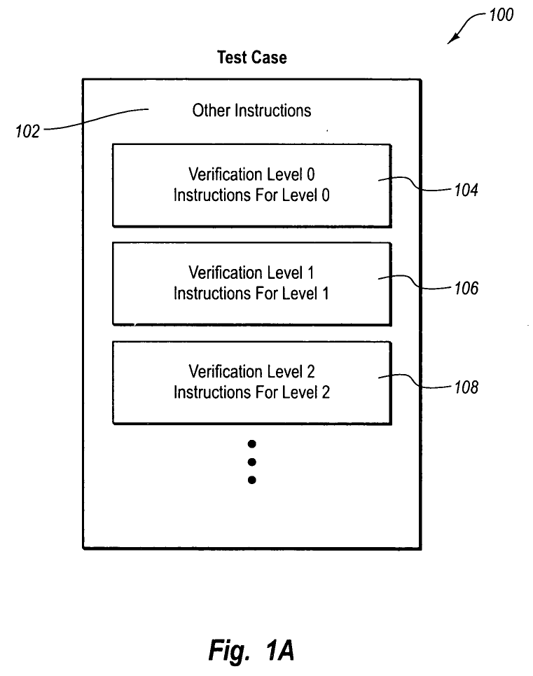

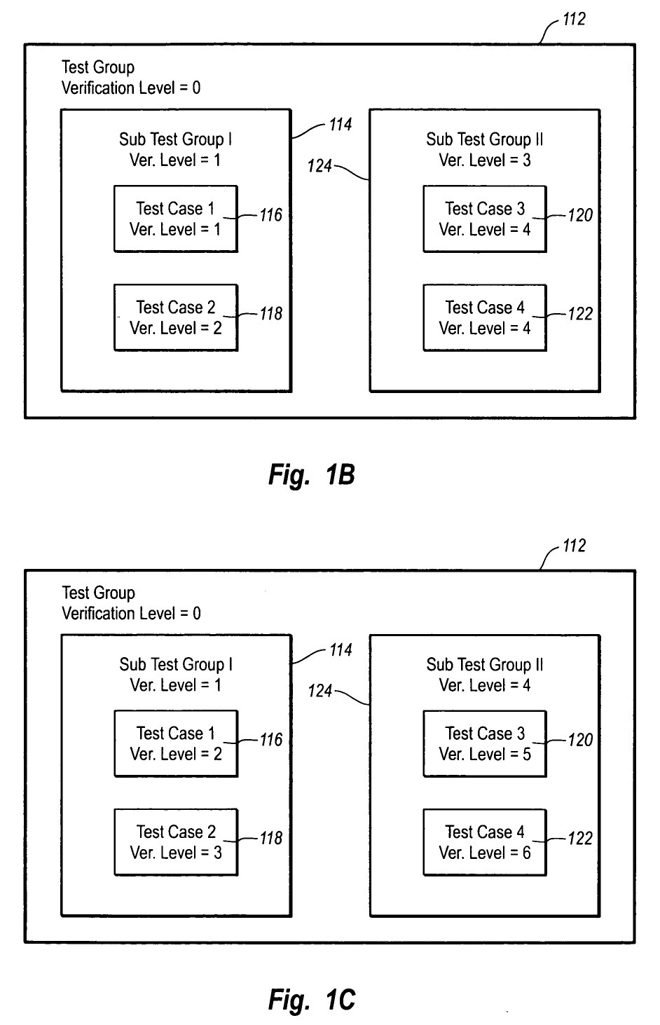

FIG. 1A shows a test case 100 with a number of test instructions that are organized into verification levels 104, 106, 108 in accordance with example embodiments. Each verification level 104, 106, 108 represents a different amount of checking or testing that may be performed when determining if the software under test functions or operates as intended when executed. For example, verification level 0 (104) includes instructions that define a first amount of testing that will be performed when the test case is set to that particular verification level. The amount of checking defined by the software testing instructions within verification level 0 (104) is different from the amount of testing in either verification level 1 (106) or verification level 2 (108). Further, the amount of verification within verification level 1 (106) is different than that for verification level 2 (108). The different verification levels 104, 106, 108 within test case 100 are a part of a verification hierarchy, which allows for scaling or extending a single test case by adding different levels of verification as needed.

The single test case 100 may be used, e.g., to test an object within the software. In such instance, an object will be invoked or called. The object may be called from within each verification level 104, 106, 108, or it may be implemented thru other instructions 102 that may be common to all verification levels within the test case 100. A desired verification level is capable of being dynamically set or tuned to any one of the verification levels 104, 106, 108 within the verification hierarchy. Depending on the desired verification level, the test case will identify and run those software testing instructions that correspond to that desired verification level. It is this ability to control the amount of verification that allows for the reusability, componentization and scalability of the present testing system.

Depending on various factors, such as the object being invoked and software under test, there are numerous verification levels 104, 106, 108 that may be desired and available within a single test case 100. For example, when testing an “insert record” object for a database application, a first verification level may invoke the insert record object without producing any recorded output just to see if the system crashes. The next level of verification may be a simple verification level used to see that the operation completed without issuing a failure (i.e., produce recorded output and analyzing it to determine pass/fail). At a basic level, the verification may not only see that insert completed without issuing a failure, but also see that the inserted information is present (i.e., read the file system or database system). At a complex level of verification not only do we care if the record is present, but also we check the file system or database to see that the insert had no unintended side-effects, e.g., the record wasn't inserted twice or didn't over-write another record. A more complete level may be to verify everything about the system, e.g., expected memory usage, disk space usage, event log message as expected, etc.

In fact, as described in greater detail below, any number of levels within the total available verification hierarchy may be identified, combined and used in testing the software. Accordingly, the above and other verification levels identified within the application are for illustrative purposes only and are not meant to limit or otherwise narrow the scope of the application.

Different verifications levels may also be used to produce the same test result, albeit at different costs or ways. For example, assume a verification level for testing “insert record” is set to check a database and ensure a record was “inserted without duplication.” The test case may achieve this desired result in any one of many fashions. For instance, the test case may have instructions that implement “find record within database,” and “find record again.” Alternatively, the test case may implement a process that “captures the database” before and after calling “insert record” and then compares the two recorded outputs to ensure that new database is equal to old database plus record. In either test, the test case ensures that the record was inserted, but not inserted twice. The difference between the two verification levels, however, is the amount of overhead required. Clearly, capturing the database twice and doing the comparison takes a lot more resources than simply checking for a second record. There may be, however, instances in which you want the additional verification to ensure that other parts of the system have not been altered, e.g., checking to make sure that no other record was altered.

Example embodiments also provide for tunable test cases that know the environment within which they are operating, and can utilize additional information produced from within that environment when testing the system. This mechanism for automatically determining what part of the development stage the software is being tested in allows tests to change their behavior depending on the development stage. Accordingly, the same test could be used for unit testing, component testing, integration testing, and system testing. In general, additional information from either the build type (e.g., debug build) or the configuration of the system (e.g., extra auditing turned on) can be used. For example, the present invention provides for a test case that determines when it is run on a debug build, as opposed to a retail build. In addition to its normal gathering of information, the test case can also collect the additional information available within the debug build for further testing and troubleshooting the software.

As described in more detail below with respect to FIGS. 1B and 1C, other example embodiments provide that the amount of checking or testing used in determining if software performs as intending can be controlled outside the test case through verification groupings. Each group may include software testing instructions organized as verification levels within the verification hierarchy described above. Further, a group may identify any number of test cases that will be run in succession, or other manner. Once each test case identified within the test group has completed its testing process, the instructions for the group verification level may be executed in order to determine the effects of the group on various parts of the system.

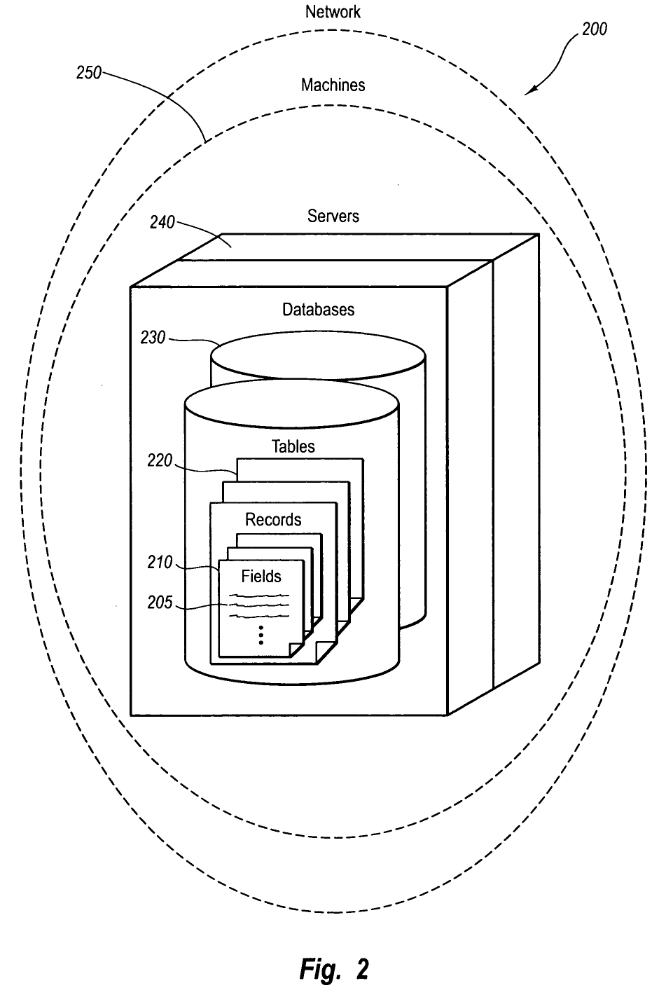

Test cases can be used as building blocks and grouped together for different types of testing. For example, “insert record” and “delete record” test cases may be grouped together, which may be expected to only have an impact on the records portion (see, e.g., records 210 FIG. 2) of a computer system. Accordingly, these test cases could be run at lower verification levels, e.g., pure stress verification level, to expedite testing process. A more thorough testing of the system, e.g., verification that the records where actually inserted and deleted or that they didn't impact other parts of the system can then be performed at the group verification level to more effectively test the system. If it is determined that one of the test cases within the test group adversely or unexpectedly affects the system, other embodiments allow for isolating the individual test cases and running them individually to determine exactly which test case caused the problem.

Any combination of test cases may be mixed and matched within a test group. In addition, the test groups themselves can be grouped into sub groups that can then be validated by another test group. This allows for tremendous flexibility in producing the desired workload on the system and to run the testing software in a most efficient manner.

FIGS. 1B and 1C illustrate several examples of how test cases can be grouped. It should be noted that any number of combinations for test cases with varying levels can be grouped and any number of groupings may further be bundled together. In addition, there is no limit to the amount of outer groupings and sub groups or combination of test cases within each group. According FIGS. 1B and 1C and the following description are used for illustrative purposes only and should not be narrowly construed to limit the scope of the application to only these embodiments.

As shown in FIG. 1B, several test cases with varying or similar verification levels may be grouped together. For example, test case 3 (120) and test case 4 (122) may be grouped together to make up sub test group II (124). Test cases 3 (120) and test case 4 (122) are set to the same testing level from within the verification hierarchy (i.e., verification level=4). Sub test group II (124), however, is set to another verification level (i.e., verification level=3) within the hierarchy. Although typically the verification level for the group will be a more thorough testing level, this does not always need to be the case. For example, sub test group I (114) is set to a verification level (verification level=1) that is the same as the verification level of test case 1 (116). In addition, the test cases within a group do not have to be set at the same level, as shown in sub test group I (114) Where test case 1 (116) is set at a verification level=1, whereas test case 2 (118) is set at a verification level=2.

As mentioned above, the test groups themselves can be grouped together and can have different verification levels. For example, sub test group I (114) and sub test group II (124) are grouped together in test group (112) with different verification levels (i.e., verification levels equal to 1 and 3, respectively). Further, test group (112) has a different verification level (verification level=0) than either sub test groups I and II (114 and 124, respectively). In fact, as illustrated in FIG. 1C, each test case 116, 118, 120, 122 and each test group 112, 114, 124 may be different. Of course, any combination of test cases or groupings may have the same verification levels as well.

FIG. 2 illustrates various parts of a computer system capable of being tested using the tunable amounts of testing verification in accordance with example embodiments. Network 200 may include multiple machines 250 and multiple servers 240 with databases 230. Within the databases 230 are multiple tables 220, each table includes multiple records 210 that have multiple fields 205. It should be understood, however, that this and other arrangements and process described herein are set fourth for purposes of example only, and other arrangements and elements (e.g., machines, interfaces, functions, orders of elements, etc.) can be added or used instead and/or some elements may be omitted altogether.

Any item within, or even possibly outside, Network 200 may be tested in any one or more various ways and with any combination of test cases and groupings. For example, referring to FIG. 1B, test case 1 (116) may be a test case for tables 220 and test case 2 (118) could be a test case for records 210. Further, test case 3 (120) and test case 4 (122) might be field 205 test cases. Accordingly, sub test group I (114) could test at the tables level 220, sub test group II (124) could test at databases level 230, and test group 112 could check at an even higher level of servers 240, machines 250, and/or network 200. Of course, as previously mentioned, any combination of test cases and groupings to test any part of the system is possible. Accordingly, the above described test cases and groups are used for illustrative purposes only and are not meant to narrow or otherwise limit the scope of the present invention.

The present invention may also be described in terms of methods comprising functional steps and/or non-functional acts. The following is a description of steps and acts that may be performed in practicing the present invention. Usually, functional steps describe the invention in terms of results that are accomplished, whereas non-functional acts describe more specific actions for achieving a particular result. Although the functional steps and non-functional acts may be described or claimed in a particular order, the present invention is not necessarily limited to any particular ordering or combination of acts and/or steps.

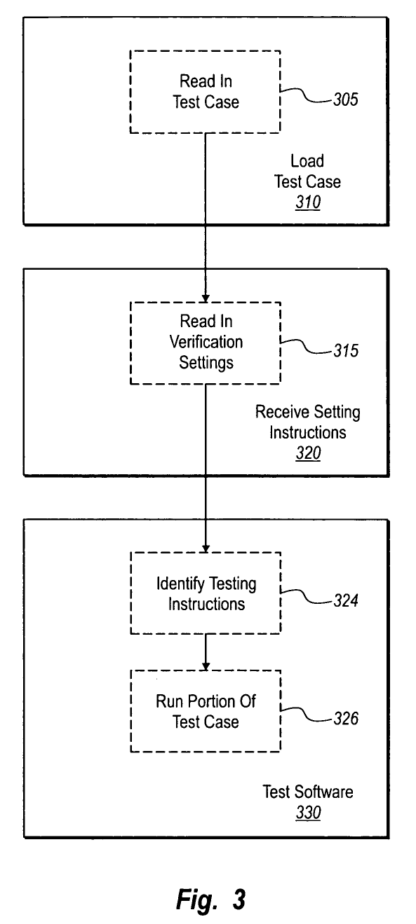

FIG. 3 illustrates exemplary embodiments for steps and acts in verifying software under test with tunable test cases capable of being set to any number of verification levels. A step for loading (310) test cases may include an act of reading in (305) one or more test cases that include a number of software testing instructions organized as a plurality of verification levels within a verification hierarchy. The verification levels within the verification hierarchy define different amounts of checking to perform for determining if the software functions as intended when executed. Further, a step for receiving verification setting instructions (320) may include an act of reading in verification settings that define desired verification levels within the verification hierarchy. As described above, the software may be tested in step (330) by the acts of identifying (324) software testing instructions within the test cases that correspond to the desired verification levels and running (326) the test cases that correspond thereto.

Other embodiments provide that a first test case may be part of a first test group (see, e.g., FIGS. 1B and 1C). The first test group may include software testing instructions organized as one or more verification levels within the verification hierarchy. Further, the verification settings that define the desired verification levels for the test cases also define desired verification levels for the first test group. Accordingly, software testing instructions within the first test group that correspond to the desired verification levels may be identified, wherein that portion of the first test group that corresponds to the desired verification levels may be run.

The verification settings may define a single desired verification level for the first test case and the first test group, for example, as shown in FIG. 1B where test case 1 (116) has the same verification level sub test group I (114)). Further, a second test case may be part of the first test group and the verification settings may define a desired verification level for the second test case different from the desired verification level for the first test group (e.g., test case 2 (118) has a different verification level than test case 1 (116) in FIG. 1B). Alternatively, the verification settings may define a desired verification level for the first test case different from a desired verification level for the first test group, e.g., as shown in FIG. 1C test case 1 (116) is set at a different verification level than sub test group I (114). Moreover, a second test case may be part of the first test group and the verification settings can define a desired verification level for the second test case different from the desired verification level for the first test group (e.g., test case 2 (118) is set to a different verification level than sub test group I (114) in both FIGS. 1B and 1C). In addition, the verification settings may define a desired verification level for the second test case different from the desired verification level for the first test case (as shown in FIG. 1C, where test case 2 (118) is set to a different verification level than test case 1 (116)).

In yet other example embodiments, a second test case may be part of the first test group, and a third and fourth are part of a second test group, e.g., as shown in FIGS. 1B and 1C. Similar to the first test group, the second test group includes software testing instructions organized as verification levels within the verification hierarchy. Further, the verification settings that define the desired verification levels for the test cases may also define verification levels for the second test group. One embodiment provides that the verification settings define different desired verification levels for all of the test cases and test groups, e.g., as shown in FIG. 1C. Further, the first and second test groups may be part of a third test group setup similarly to that of the first and second test groups. The verification levels for the different test groups may be in any combination ranging from all the same to all different levels.

In still yet other embodiments, the software instructions may determine that software (e.g., debug) information is available and may use the information for troubleshooting if it is determined that the software does not function as intended when executed. Further, the portions of the test cases that correspond to the desired verification levels may or may not produce any test output. If outputs are produce, the test cases are capable of verifying the recorded output with expected values.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

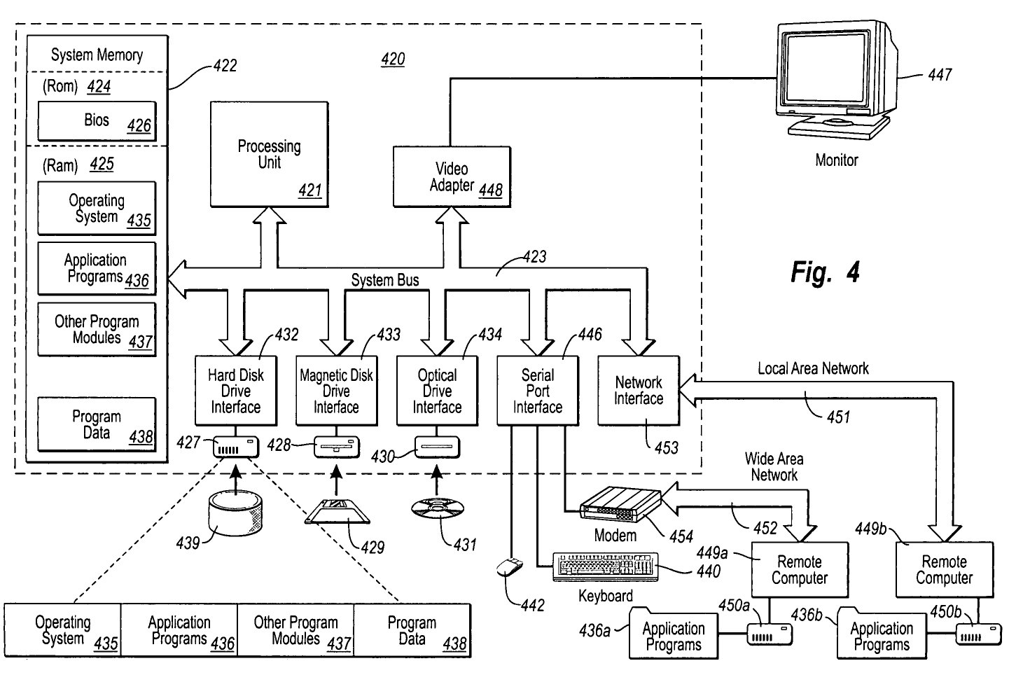

FIG. 4 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 4, an exemplary system for implementing the invention includes a general purpose computing device in the form of a conventional computer 420, including a processing unit 421, a system memory 422, and a system bus 423 that couples various system components including the system memory 422 to the processing unit 421. The system bus 423 may be any of several types of bus structures including a memory bus or memory controller, a peripheral bus, and a local bus using any of a variety of bus architectures. The system memory includes read only memory (ROM) 424 and random access memory (RAM) 425. A basic input/output system (BIOS) 426, containing the basic routines that help transfer information between elements within the computer 420, such as during start-up, may be stored in ROM 424.

The computer 420 may also include a magnetic hard disk drive 427 for reading from and writing to a magnetic hard disk 439, a magnetic disk drive 428 for reading from or writing to a removable magnetic disk 429, and an optical disk drive 430 for reading from or writing to removable optical disk 431 such as a CD-ROM or other optical media. The magnetic hard disk drive 427, magnetic disk drive 428, and optical disk drive 430 are connected to the system bus 423 by a hard disk drive interface 432, a magnetic disk drive-interface 433, and an optical drive interface 434, respectively. The drives and their associated computer-readable media provide nonvolatile storage of computer-executable instructions, data structures, program modules and other data for the computer 420. Although the exemplary environment described herein employs a magnetic hard disk 439, a removable magnetic disk 429 and a removable optical disk 431, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 439, magnetic disk 429, optical disk 431, ROM 424 or RAM 425, including an operating system 435, one or more application programs 436, other program modules 437, and program data 438. A user may enter commands and information into the computer 420 through keyboard 440, pointing device 442, or other input devices (not shown), such as a microphone, joy stick, game pad, satellite dish, scanner, or the like. These and other input devices are often connected to the processing unit 421 through a serial port interface 446 coupled to system bus 423. Alternatively, the input devices may be connected by other interfaces, such as a parallel port, a game port or a universal serial bus (USB). A monitor 447 or another display device is also connected to system bus 423 via an interface, such as video adapter 448. In addition to the monitor, personal computers typically include other peripheral output devices (not shown), such as speakers and printers.

The computer 420 may operate in a networked environment using logical connections to one or more remote computers, such as remote computers 449a and 449b. Remote computers 449a and 449b may each be another personal computer, a server, a router, a network PC, a peer device or other common network node, and typically include many or all of the elements described above relative to the computer 420, although only memory storage devices 450a and 450b and their associated application programs 436a and 436b have been illustrated in FIG. 4. The logical connections depicted in FIG. 4 include a local area network (LAN) 451 and a wide area network (WAN) 452 that are presented here by way of example and not limitation. Such networking environments are commonplace in office-wide or enterprise-wide computer networks, intranets and the Internet.

When used in a LAN networking environment, the computer 420 is connected to the local network 451 through a network interface or adapter 453. When used in a WAN networking environment, the computer 420 may include a modem 454, a wireless link, or other means for establishing communications over the wide area network 452, such as the Internet. The modem 454, which may be internal or external, is connected to the system bus 423 via the serial port interface 446. In a networked environment, program modules depicted relative to the computer 420, or portions thereof, may be stored in the remote memory storage device. It will be appreciated that the network connections shown are exemplary and other means of establishing communications over wide area network 452 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. In a computer system that includes software under test, a method of verifying the software with one or more tunable test cases that are capable of being set to any of a plurality of verification levels, the method comprising acts of:
reading in one or more test cases that include a plurality of software testing instructions organized as a plurality of verification levels within a verification hierarchy, wherein at least two verification levels within the verification hierarchy define different amounts of checking to perform for determining if the software functions as intended when executed;
reading in verification settings that define one or more desired verification levels within the verification hierarchy;
identifying a portion of the plurality of software testing instructions within the one or more test cases that corresponds to the one or more desired verification levels; and
running the portion of the one or more test cases that corresponds to the one or more desired verification levels.

2. The method of claim 1, wherein a first test case from the one or more test cases is part of a first test group, the first test group including one or more software testing instructions organized as one or more verification levels within the verification hierarchy, and wherein the verification settings that define the one or more desired verification levels for the one or more test cases also define one or more desired verification levels for the first test group.

3. The method of claim 2, further comprising acts of:
identifying a portion of the one or more software testing instructions within the first test group that corresponds to the one or more desired verification levels; and
running a portion of the first test group that corresponds to the one or more desired verification levels.

4. The method of claim 3, wherein the verification settings define a single desired verification level for the first test case and the first test group.

5. The method of claim 3, wherein the verification settings define a desired verification level for the first test case that is different from a desired verification level for the first test group.

6. The method of claim 4, wherein a second test case from the one or more test cases is part of the first test group, and wherein the verification settings define a desired verification level for the second test case different from the desired verification level for the first test group.

7. The method of claim 5, wherein a second test case from the one or more test cases is part of the first test group, and wherein the verification settings define a desired verification level for the second test case that is different from the desired verification level for the first test group.

8. The method of claim 7, wherein verification settings define a desired verification level for the second test case that is different from the desired verification level for the first test case.

9. The method of claim 3, wherein a second test case from the one or more test cases is part of the first test group, and wherein third and fourth test cases from the one or more test cases are part of a second test group, the second test group including one or more software testing instructions organized as one or more verification levels within the verification hierarchy, and wherein the verification settings that define the one or more desired verification levels for the one or more test cases also define one or more desired verification levels for the second test group, the method further comprising acts of:
identifying a portion of the one or more software testing instructions within the second test group that corresponds to the one or more desired verification levels; and
running a portion of the second test group that corresponds to the one or more desired verification levels.

10. The method of claim 9, wherein the verification settings define different desired verification levels for each of the first test case, the second test case, the third test case, the fourth test case, the first test group and the second test group.

11. The method of claim 10, wherein the first and second test groups are part of a third test group, the third test group including one or more software testing instructions organized as one or more verification levels within the verification hierarchy, and wherein the verification settings that define the one or more desired verification levels for the one or more test cases also define one or more desired verification levels for the third test group, the method further comprising acts of:
identifying a portion of the one or more software testing instructions within the third test group that corresponds to the one or more desired verification levels; and
running a portion of the third test group that corresponds to the one or more desired verification levels.

12. The method of claim 11, wherein the verification settings define a desired verification level for the third test group different from each of the first test case, the second test case, the third test case, the fourth test case, the first test group and the second test group.

13. The method of claim 1, wherein at least a portion of at least one of the plurality of software instructions determines that software information is available and uses the information for troubleshooting the software if it is determined that the software does not function as intended when executed.

14. The method of claim 13, wherein the software information available is debug information.

15. The method of claim 1, wherein the portion of the one or more test cases that corresponds to the one or more desired verification levels does not produce any testing output.

16. The method of claim 1, wherein the portion of the one or more test cases that corresponds to the one or more desired verification levels produces one or more test outputs for verifying the software.

17. In a computer system that includes software under test, a method of verifying the software with one or more tunable test cases that are capable of being set to any of a plurality of verification levels, the method comprising steps for:
loading one or more test cases that include a plurality of software testing instructions organized as a plurality of verification levels within a verification hierarchy, wherein at least two verification levels within the verification hierarchy define different amounts of testing to perform for determining if the software functions as intended when executed;
receiving verification setting instructions for one or more desired verification levels from within the verification hierarchy for use in testing the software; and
testing the software at the one or more desired verification levels by running the one or more test cases that include the plurality of software testing instructions that correspond to the one or more desired verification levels.

18. The method of claim 17, wherein a first test case from the one or more test cases is part of a first test group, the first test group including one or more software testing instructions organized as one or more verification levels within the verification hierarchy, and wherein the verification setting instructions for the one or more desired verification levels define a desired verification level for the first test case different from a desired verification level for the first test group, further comprising acts of:
identifying a portion of the one or more software testing instructions within the first test group that corresponds to the one or more desired verification levels; and
running a portion of the first test group that corresponds to the one or more desired verification levels.

19. The method of claim 18, wherein a second test case from the one or more test cases is part of the first test group, and wherein the verification setting instructions define a desired verification level for the second test case that is different from a desired verification level for the first test group.

20. The method of claim 19, wherein verification setting instructions for the desired verification levels define a single verification level for the first and second test cases.

21. In a computer system that includes software under test, a computer program product comprising one or more computer readable media carrying computer executable instructions that implement a method of verifying the software with one or more tunable test cases that are capable of being set to any of a plurality of verification levels, the method comprising acts of:
reading in one or more test cases that includes a plurality of software testing instructions organized as a plurality of verification levels within a verification hierarchy, wherein at least two verification levels within the verification hierarchy define different amounts of testing to perform for determining if the software functions as intended when executed;
reading in verification settings that define a desired verification level within the verification hierarchy;
identifying a portion of the plurality of software testing instructions within the one or more test cases that corresponds to the desired verification level; and
running the portion of the one or more test cases that corresponds to the desired verification level.

22. The computer program product of claim 21, wherein a first test case from the one or more test cases is part of a first test group, the first test group including one or more software testing instructions organized as one or more verification levels within the verification hierarchy, and wherein the verification settings that define the one or more desired verification levels for the one or more test cases also define one or more desired verification levels for the first test group.

23. The computer program product of claim 22, wherein the verification settings define a single desired verification level for the first test case and the first test group, and wherein a second test case from the one or more test cases is part of the first test group, and wherein the verification settings define a desired verification level for the second test case different from a desired verification level for the first test group.

24. The computer program product of claim 22, wherein a second test case from the one or more test cases is part of the first test group, and wherein third and fourth test cases from the one or more test cases are part of a second test group, the second test group including one or more software testing instructions organized as one or more verification levels within the verification hierarchy, and wherein the verification settings that define the one or more desired verification levels for the one or more test cases also define one or more desired verification levels for the second test group, and wherein the verification settings define different desired verification levels for each of the first test case, the second test case, the third test case, the fourth test case, the first test group and the second test group.

25. In a computer system that includes software under test, a computer program product comprising one or more computer readable media carrying computer executable instructions that implement a method of verifying the software with one or more tunable test cases that are capable of being set to any of a plurality of verification levels, the method comprising steps for:
loading one or more test cases that include a plurality of software testing instructions organized as a plurality of verification levels within a verification hierarchy, wherein at least two verification levels within the verification hierarchy define different amounts of checking to perform for determining if the software functions as intended when executed;
receiving verification setting instructions for one or more desired verification levels from within the verification hierarchy for use in testing the software; and
testing the software at the one or more desired verification levels by running the one or more test cases that include the plurality of software testing instructions that correspond to the one or more desired verification levels.

26. The computer program product of claim 25, wherein a first test case from the one or more test cases is part of a first test group, the first test group including one or more software testing instructions organized as one or more verification levels within the verification hierarchy, and wherein the verification setting instructions for the one or more desired verification levels define one or more desired verification levels for both the first test case and the first test group.

27. The computer program product of claim 26, further comprising acts of:
identifying a portion of the one or more software testing instructions within the first test group that corresponds to the one or more desired verification levels; and
running a portion of the first test group that corresponds to the one or more desired verification levels.

28. The computer program product of claim 27, wherein the verification setting instructions define a single desired verification level for the first test case and the first test group.

29. The computer program product of claim 27, wherein the verification setting instructions define a desired verification level for the first test case that is different from a desired verification level for the first test group.

30. The computer program product of claim 28, wherein a second test case from the one or more test cases is part of the first test group, and wherein the verification setting instructions define a desired verification level for the second test case that is different from the desired verification level for the first test group.

31. The computer program product of claim 29, wherein a second test case from the one or more test cases is part of the first test group, and wherein the verification setting instructions define a desired verification level for the second test case that is different from the desired verification level for the first test group.

32. The computer program product of claim 31, wherein verification setting instructions define a desired verification level for the second test case that is different from the desired verification level for the first test case.

33. The computer program product of claim 27, wherein a second test case from the one or more test cases is part of the first test group, and wherein third and fourth test cases from the one or more test cases are part of a second test group, the second test group including one or more software testing instructions organized as one or more verification levels within the verification hierarchy, and wherein the verification setting instructions that define the one or more desired verification levels for the one or more test cases also define one or more desired verification levels for the second test group, the method further comprising acts of:
identifying a portion of the one or more software testing instructions within the second test group that corresponds to the one or more desired verification levels; and
running a portion of the second test group that corresponds to the one or more desired verification levels.

34. The computer program product of claim 33, wherein the verification setting instructions define different desired verification levels for each of the first test case, the second test case, the third test case, thee fourth test case, the first test group and the second test group.

35. The computer program product of claim 34, wherein the first and second test groups are part of a third test group, the third test group including one or more software testing instructions organized as one or more verification levels within the verification hierarchy, and wherein the verification setting instructions that define the one or more desired verification levels for the one or more test cases also define one or more desired verification levels for the third test group, the method further comprising acts of:
identifying a portion of the one or more software testing instructions within the third test group that corresponds to the one or more desired verification levels; and
running a portion of the third test group that corresponds to the one or more desired verification levels.

36. The computer program product of claim 35, wherein the verification setting instructions define a desired verification level for the third test group that is different from the each of the first test case, the second test case, the third test case, the fourth test case, the first test group and the second test group.

37. The computer program product of claim 25, wherein at least a portion of at least one of the plurality of software instructions determines that software information is available and uses the information for troubleshooting the software when it is determined that the software does not function as intended when executed.

38. The method of claim 37, wherein the software information available is debug information.

39. The computer program product of claim 25, wherein the portion of the plurality of software testing instructions that corresponds to the one or more desired verification levels does not produce any testing output.

40. The computer program product of claim 25, wherein the portion of the plurality of software testing instructions that corresponds to the one or more desired verification levels produces one or more test outputs used to verify the software functions as intended.
